(19) United States
(12) Patent Application Publication
(10) Pub. No.: US 2021/0372700 A1
(43) Pub. Date: Dec. 2, 2021

(54) SYSTEM AND METHOD FOR PRODUCING CEMENT CLINKER

(71) Applicants: THYSSENKRUPP INDUSTRIAL SOLUTIONS AG, Essen (DE); thyssenkrupp AG, Essen (DE)

(72) Inventors: Christian BRINKMANN, Bielefeld (DE); Klaus ADLER, Rheda-Wiedenbrück (DE); Reinhard BEILMANN, Oelde (DE)

(73) Assignees: THYSSENKRUPP INDUSTRIAL SOLUTIONS AG, Essen (DE); thyssenkrupp AG, Essen (DE)

(21) Appl. No.: 16/636,577

(22) PCT Filed: Aug. 15, 2018
(86) PCT No.: PCT/EP2018/072079

§ 371 Date: Feb. 4, 2020

(30) Foreign Application Priority Data
Aug. 22, 2017 (DE) 10 2017 119 155.0

(51) Int. Cl. F27B 7/36; F27D 17/00

(52) U.S. Cl. CPC F27B 7/36; F27D 17/008

(57) ABSTRACT

A bypass system may be utilized in installations and methods for producing cement clinker. A portion of a kiln offgas produced in a kiln may be branched off as bypass gas via a bypass line connected between the kiln and a calciner. In some cases 3 to 15% of the kiln offgas is branched off as the bypass gas. The bypass gas may be cooled to a temperature in a range from 300 to 550° C. and dedusted in a temperature range from 300 to 550° C. The dedusted bypass gas may then be recirculated to the calciner and/or into a tertiary air line arranged between the cooler and the calciner and/or into a region between the kiln and the calciner.

The invention relates to an installation and to a method for producing cement clinker.

As a result of the raw materials and fuels used during the production of cement clinker, harmful substances which form circulations between the preheater and the kiln are released. For the purpose of reducing the harmful substances, it is therefore known to branch off a portion of the kiln offgases via a bypass line and to clean it of the harmful substances. Depending on the amount of harmful substances, bypass rates of 3% to over 30% are used here.

DE 38 29 853 C1 has disclosed a method for reducing salt circulations during the production of cement clinker, in which, via a bypass line, a portion of the kiln offgases that is laden with a harmful substance is removed, and is then cooled and supplied to a dust separation means. The dedusted bypass gas is recirculated into the raw meal preheater. This also offers the possibility of a denitrification device arranged after the preheater also being able to be used for the denitrification of the bypass gases. However, there is the disadvantage that a predefined preheater, in terms of the quantity of gas which is able to be passed through, is limited by the size of its cyclones and of the fan arranged thereafter. The kiln offgases therefore have to be correspondingly reduced, whereby the clinker output of the kiln installation is lowered.

The invention is then based on the object of specifying a concept for denitrification of the bypass gases in which the output of the kiln installation is influenced to a far lesser extent.

According to the invention, said object is achieved by the features of claims 1 and 7.

The installation according to the invention for producing cement clinker consists substantially of
(a) a preheater for preheating raw cement material to form preheated raw cement meal,
(b) a calciner for calcining the preheated raw cement meal to form calcined raw cement meal,
(c) a kiln for final burning of the calcined raw cement meal to form cement clinker, wherein kiln offgases are produced,
(d) a cooler for cooling the cement clinker, and
(e) a bypass system having
   (e1) a bypass line connected between the kiln and the calciner and serving for branching off, as bypass gas, a portion of the kiln offgases flowing from the kiln to the calciner,
   (e2) a cooling device for cooling the bypass gas, and
   (e3) a dust separator for separating dust contained in the bypass gas, which has an inlet for the supply of the cooled bypass gas, has at least one discharge opening for the removal of the separated dust, and has an outlet opening for a dedusted bypass gas.

Furthermore, provision is made between the outlet opening of the dust separator and the calciner of a recirculation line for the dedusted bypass gas, wherein the recirculation line opens into the calciner and/or into a tertiary air line arranged between the cooler and the calciner and/or into a region between the kiln and the calciner.

The method according to the invention for producing cement clinker is characterized in that the raw cement meal is preheated in a preheater, is calcined in a calciner and is subjected to final burning in a kiln, and the cement clinker produced in the process is then cooled in a cooler, wherein a portion of a kiln offgas produced in the kiln is branched off as bypass gas via a bypass line connected between the kiln and the calciner, is cooled and is dedusted. The dedusted bypass gas is recirculated to the calciner and/or into a tertiary air line arranged between the cooler and the calciner and/or into a region between the kiln and the calciner.

The recirculation of the dedusted bypass gas into the calciner or into a region between the kiln and the calciner makes it possible for the cooled bypass gas, in particular if it has been cooled with air, to be used as combustion air in the calciner. In this way, the recirculated bypass gas substitutes for a portion of the tertiary air, so that there is no significant change to the quantity of gas through the preheater. The kiln can thus be operated with a substantially unchanged clinker output.

The investigations on which the invention is based have also revealed here that no significant disadvantages with regard to the heat consumption of the overall installation occur, it however being possible for the installations to be used for NOₓ reduction in the calciner (SNCR) or in the kiln offgas (SCR), with the result that a separate means for NOₓ reduction of the bypass offgas is not necessary.

According to a preferred configuration of the invention, the bypass gas is cooled in the cooling device as a result of air being supplied, whereby the gaseous harmful substances in the bypass gas condense on the entrained dust and can be separated off in the subsequent dust separator. Furthermore, the oxygen content of the bypass gas is correspondingly increased by mixing with air, with the result that the recirculated bypass gas can be used in the calciner as combustion air.

According to a further configuration of the invention, the dust separator is designed as a hot-gas filter for a temperature range exceeding 300° C. For this purpose, use may be made for example of an electrostatic filter, a ceramic filter or else at least one cyclone. The temperature of the bypass gases must on the one hand be so low that the harmful substances to be separated off accumulate on the dust particles and on the other hand be as high as possible so as to avoid unnecessary heat losses. Depending on the harmful substances to be separated off, the hot-gas filtration temperature, that is to say the temperature at which the bypass gas is supplied to the dust separator, is 300 to 550° C., preferably 400 to 500° C.

After the dedusted bypass gas recirculated in the region of the calciner replaces a portion of the tertiary air that is otherwise required in the calciner, the tertiary air not required in the calciner (waste air of the cooler from a front region of the cooler) may be used in other ways, in particular for heat recovery, as a result of which the overall heat balance is further improved.

In the investigations on which the invention is based, it has furthermore been found that expediently no more than 3 to 15%, preferably 5 to 12%, of the kiln offgases produced in the kiln should be branched off as bypass gas. At a higher bypass rate, the cooler efficiency would otherwise be significantly reduced owing to the then sharp drop in the quantity of tertiary air. In such a case, however, the lower cooler efficiency can be expediently compensated by the provision of an installation for heat recovery that is operated with the cooler middle air.

In the drawing,

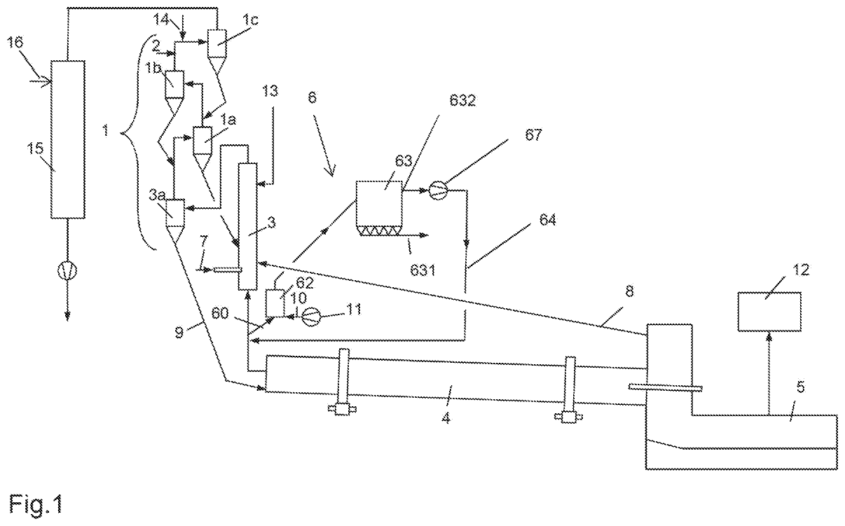

FIG. 1 shows a schematic illustration of an installation for producing cement clinker, with recirculation of the dedusted bypass gas into a region between a kiln and a calciner,

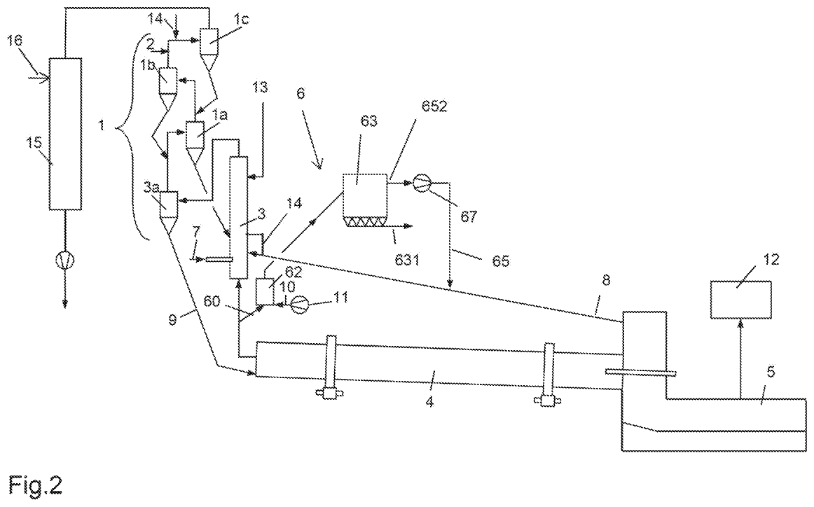

FIG. 2 shows a schematic illustration of an installation for producing cement clinker, with recirculation of the dedusted bypass gas into a tertiary air line arranged between a cooler and a calciner, and

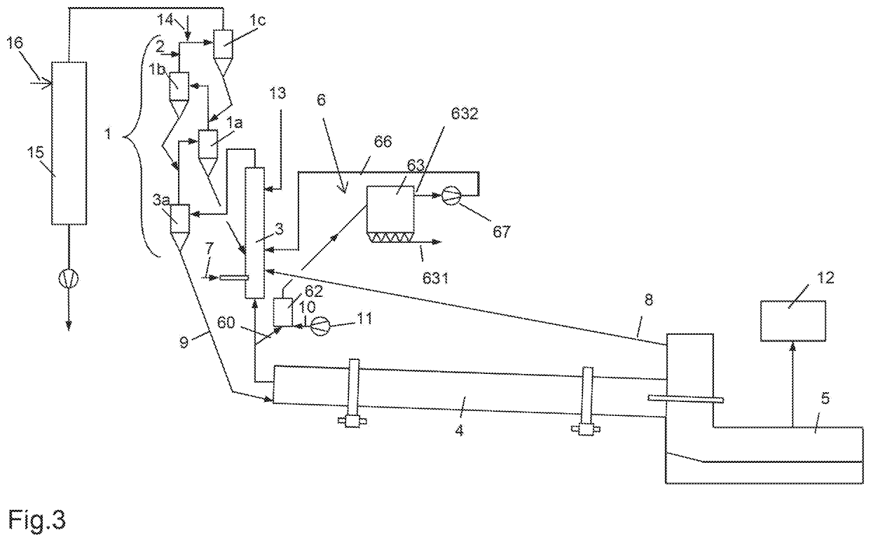

FIG. 3 shows a schematic illustration of an installation for producing cement clinker, with recirculation of the dedusted bypass gas directly into the calciner.

The installation illustrated in FIG. 1 consists substantially of a preheater 1 for preheating raw cement material 2 to form preheated raw cement meal, a calciner 3 for calcining the preheated raw cement meal to form calcined raw cement meal, a kiln 4 for final burning of the calcined raw cement meal to form cement clinker, a cooler 5 for cooling the cement clinker and a bypass system 6.

In the illustrated exemplary embodiment, the preheater 1 is designed as a suspension preheater having multiple cyclones 1a to 1c arranged one above the other. The calciner 3 is formed by an entrained flow reactor and is flowed through by the offgases of the rotary kiln 4 from bottom to top. The preheated raw cement meal is fed in conventional form into the kiln offgas in a lower region of the calciner 3. In the region of the calciner 3, provision is additionally made of one or more fuel supply points 7, via which the fuel required for the calcination is supplied. The combustion air is supplied via a tertiary air line 8 coming from the cooler 5, wherein the tertiary air is, if desired, introduced in a stepped manner, that is to say at different heights. At the end of the calciner 3, provision is made of a separating cyclone 3a, which separates the offgas from the calcined raw cement meal. While the offgas is used for preheating the raw cement material 2 in the preheater 1, the calcined raw cement material passes into the kiln 4 via a line 9. The kiln 4 is preferably designed as a rotary kiln, to which the cooler 5 is directly connected.

For the purpose of interrupting any circulations of harmful substances, such as circulations of alkalines or chlorines, provision is made that the bypass system 6 comprises a bypass line 60 connected between the kiln 4 and the calciner 3 and serving for branching off, as bypass gas, a portion of the offgases flowing from the kiln 4 to the calciner 3. The bypass line 60 opens into a cooling device 61 for cooling the bypass gas, wherein air 10 is supplied via a cooling-air supply opening with the aid of a fan 11.

The bypass gas has a temperature in the range from 1100 to 1200° C. at the branch between the kiln 4 and the calciner 3, and is cooled in the cooling device 61 to a temperature in the range from 300 to 550° C., preferably in the range from 400 to 500° C. At this temperature, the gas then flows into a dust separator 63, which is designed as a hot-gas filter for a temperature range exceeding 300° C., in particular for a range of 300 to 550° C., preferably 400 to 500° C. Said dust separator is formed for example by an electrostatic filter, a ceramic filter or at least one cyclone. The separated dust is discharged via a discharge opening 631, while the dedusted bypass gas is recirculated via an outlet opening 632 and a recirculation line 64 into a region between the kiln and the calciner. For this purpose, the bypass system 6 comprises a fan 67, with the aid of which the bypass gas is branched off and the dedusted bypass gas is recirculated.

The oxygen content in the recirculated, dedusted bypass gas has been increased by the cooling air 10 in the cooling device 11, and said dedusted bypass gas then serves, together with the kiln offgases, as combustion air in the calciner 3. It thus replaces a portion of the tertiary air supplied via the tertiary air line 8. The unused portion of the tertiary air arising in the cooler 5 and possibly also another waste air of the cooler 5 may be used for example in a heat recovery installation 12 in order to further improve the heat balance.

The offgases from the kiln 4 and the calciner 3 normally contain nitrogen oxides in such large quantities that denitrification measures have to be implemented. In the region of the calciner 3, in particular in the upper region thereof, it has been found out to be advantageous if denitrification according to the SNCR process is carried out there in that an ammonia-containing reducing agent 13 is introduced. The SNCR process is particularly expedient in the upper region of the calciner 3, since there, the temperatures, optimal for the SNCR process, are in a range around 950° C. The recirculation of the bypass gas into the calciner thus also has the further effect that the SNCR process may also be applied to the bypass gas. Were the bypass gas released into the atmosphere instead, separate measures would have to be implemented. Since the temperatures in the bypass system are too low for the SNCR process, either an increase in temperature would have to be realized or another denitrification process would have to be used.

As an alternative or additional denitrification measure, denitrification of the offgases by means of the SCR process can be considered. For this purpose, downstream of the preheater in the flow direction of the offgases, there is arranged an SCR catalytic converter 15, in which injection of an ammonia-containing reducing agent 16 can likewise be provided. The recirculation of the bypass gases allows these, together with the kiln/calciner offgases, to be denitrified.

The exemplary embodiment as per FIG. 2 differs only in that, for the recirculation of the dedusted bypass gases, provision is made of a recirculation line 65 which opens into the tertiary air line 8 leading from the cooler 5 to the calciner 3. In this variant too, however, the recirculated bypass gas replaces a portion of the tertiary air, which can then be used for example in the heat recovery device 12.

As already mentioned previously, the tertiary air may also be supplied in a stepped manner, that is to say at multiple levels. Therefore, in the exemplary embodiment in FIG. 2, provision is made of a branch 14 of the tertiary air line 8, via which branch tertiary air or a mixture of tertiary air and dedusted bypass gas can be supplied at a higher level of the calciner 3.

Finally, FIG. 3 shows an exemplary embodiment in which a recirculation line 66 for the dedusted bypass gas opens directly into the calciner 3, with the result that the tertiary air, via the tertiary air line 8, and the dedusted bypass gas, via the recirculation line 66, are supplied separately from one another. In the exemplary embodiment illustrated, provision is again made of a stepped air supply means in that the tertiary air is introduced further down and the dedusted bypass gas is introduced further up into the calciner 3. The recirculation of the bypass gas into the calciner has in particular the following advantages:
use of the SNCR or SCR device, provided for the kiln offgases, for the dedusted bypass gas,
approximately equal speeds in the cyclone of the preheater even with different bypass rates,
a higher tertiary air temperature, which results from a reduction in the quantity of tertiary air,
a better capacity flow ratio between gas and meal in the preheater, with the result that the meal is preheated to a higher temperature before passing into the calciner,
a higher kiln offgas temperature, which can preferably be used for operating an SCR catalytic converter,
higher recovery heat and temperatures for heat recovery by way of the offgases of the cooler.

1.-13. (canceled)

14. An installation for producing cement clinker, the installation comprising:
a preheater for preheating raw cement material to form preheated raw cement meal;
a calciner for calcining the preheated raw cement meal to form calcined raw cement meal;
a kiln for final burning of the calcined raw cement meal to form cement clinker, wherein kiln offgases are produced;
a cooler for cooling the cement clinker;
a bypass system that comprises
a bypass line connected between the kiln and the calciner, wherein the bypass line serves for branching off, as bypass gas, a portion of the kiln offgases flowing from the kiln to the calciner,
a cooling device for cooling the bypass gas, and
a dust separator for separating dust contained in the bypass gas, the dust separator having an inlet for supplying the cooled bypass gas, the dust separator having a discharge opening for removing the separated dust, the dust separator having an outlet opening for a dedusted bypass gas; and
a recirculation line for the dedusted bypass gas disposed between the outlet opening of the dust separator and the calciner, wherein the recirculation line opens into at least one of the calciner, a tertiary air line disposed between the cooler and the calciner, or a region between the kiln and the calciner.

15. The installation of claim 14 wherein the cooling device comprises a cooling-air supply opening for supply of cooling air into the bypass gas.

16. The installation of claim 14 wherein the dust separator is a hot-gas filter for a temperature range exceeding 300° C.

17. The installation of claim 14 wherein the dust separator comprises an electrostatic filter, a ceramic filter, or a cyclone.

18. The installation of claim 14 comprising a fan disposed in the bypass system for branching off the bypass gas and for recirculation of the dedusted bypass gas.

19. The installation of claim 14 wherein the cooler is connected to a heat recovery system for utilizing waste heat generated in the cooler.

20. A method for producing cement clinker, the method comprising:
preheating raw cement meal in a preheater;
calcining the raw cement meal in a calciner;
subjecting the raw cement meal to final burning in a kiln to produce cement clinker;
cooling the cement clinker in a cooler;
branching off a portion of kiln offgas produced in the kiln as bypass gas via a bypass line connected between the kiln and the calciner;
cooling the bypass gas;
dedusting the bypass gas; and
recirculating the dedusted bypass gas to at least one of the calciner, a tertiary air line disposed between the cooler and the calciner, or into a region between the kiln and the calciner.

21. The method of claim 20 wherein the bypass gas is cooled to a temperature in a range from 300 to 550° C.

22. The method of claim 20 wherein the bypass gas is cooled to a temperature in a range from 400 to 500° C.

23. The method of claim 20 wherein the bypass gas is dedusted in a temperature range from 300 to 550° C.

24. The method of claim 20 wherein the bypass gas is cooled with air.

25. The method of claim 20 wherein 3 to 15% of the kiln offgas produced in the kiln is branched off as the bypass gas.

26. The method of claim 20 wherein 5 to 12% of the kiln offgas produced in the kiln is branched off as the bypass gas.

27. The method of claim 20 comprising utilizing for heat recovery a portion of waste heat generated during cooling of the cement clinker in the cooler.

28. The method of claim 20 comprising denitrifying offgases flowing through the calciner, including the recirculated bypass gas, in a region of the calciner.
